(19) United States
(12) Patent Application Publication
(10) Pub. No.: US 2016/0033726 A1
(43) Pub. Date: Feb. 4, 2016

(54) LOW LOSS FIBER OPTIC HARNESS

(71) Applicant: NEXANS, Paris (FR)

(72) Inventors: Paul Michael Good, New Holland, PA (US); Michael Connaughton, Holly Springs, NC (US); Ronald Lindsay, Raleigh, NC (US)

(21) Appl. No.: 14/449,656

(22) Filed: Aug. 1, 2014

(51) Int. Cl. G02B 6/42; G02B 6/26

(52) U.S. Cl. CPC G02B 6/4203; G02B 6/262

(57) ABSTRACT

The present arrangement provides for a fiber optic arrangement having at least one light transmitting device, at least one light receiving device, and at least one light path between the light transmitting device and the light receiving device. The light path has first and second segments, each having first and second fiber optic element respectively, with the first segment being located proximate to the light transmitting device and where the second segment is located proximate to the light receiving device. A first fiber optic element of the first segment of the light path has a first dimension, and a second fiber optic element of the second segment of the light path has a second dimension larger than the dimension of the first fiber optic element of the first segment.

### BACKGROUND

1. Field of the Invention

The present invention relates to fiber optic networks. More particularly, the present invention relates to low loss connections for fiber optic networks.

2. Description of the Related Art

In the area of fiber optic cables and more specifically fiber optic communication arrangements employing multiple segments of fiber optic cables, the amount of signal power loss in coupling fiber optic link segments limits the overall length and/or maximum number of connectors that can be used in a given channel.

As network speeds increase, the link loss “budget” (i.e. the maximum allowable amount of power loss through a channel) decreases. One source of this signal power loss in multi-segment channels occurs in the connectors between two fiber optic cables/segments. Imperfections in fiber geometries and end face alignment in the connectors can cause signal power losses to be more than the standard allowable value of up to 0.75 dB loss per connector.

Normally, all of the fiber components in a system are selected so as to have the same numerical aperture and core diameter. These two characteristics of a fiber optic member are important for determining the loss that is experienced at a connector. The numerical aperture (NA) of a fiber is derived from the far-field measurement of the power distribution of light exiting or entering the fiber optic member. Core diameter (CD) is a near-field measurement of the power distribution of light entering or exiting a fiber optic member. Light is most efficiently coupled into a fiber optic member when the light is within the NA and CD. When the NAs and CDs of fibers that are being connected together are the same, misalignment error in the connector can result in power loss because the alignment requires significant precision.

In the prior art, existing solutions rely on increasingly tighter specifications for fiber geometries and tolerances on connectors and fiber optic performance. For example, a manufacturer may decrease the numerical aperture specification from 0.200 μm+/−0.015 to 0.200 μm+/−0.010. Although this provides a workable solution, these types of improvements only produce small incremental improvements to the signal power loss, and come at ever increasing manufacturing costs related to meeting such standards.

### OBJECTS AND SUMMARY

The present arrangement provides a novel harness or patch cord implementation for connecting two segments of fiber optic cables in a manner that provides significantly less connector loss by ensuring that light that is launched from a transmitter Tx into a first fiber optic member, continuously travels into subsequent fiber optic members each with a larger numerical aperture and/or core diameter than the prior fiber member/segment as explained in more detail in the detailed description. This design decreases the connector loss and consequently increases the overall length of the fiber optic channel and/or number of connectors within the channel without exceeding the power budget. Since the vast majority of fiber optic technologies found in the optical LAN transmit in one direction on each fiber, the arrangement of such novel patch cords can be easily managed.

To this end, the present arrangement provides for a fiber optic arrangement having at least one light transmitting device, at least one light receiving device, and at least one light path between the light transmitting device and the light receiving device. The light path has first and second segments, each having first and second fiber optic element respectively, with the first segment being located proximate to the light transmitting device and where the second segment is located proximate to the light receiving device.

A first fiber optic element of the first segment of the light path has a first dimension, and a second fiber optic element of the second segment of the light path has a second dimension larger than the dimension of the first fiber optic element of the first segment.

### BRIEF DESCRIPTION OF THE DRAWINGS

The present invention can be best understood through the following description and accompanying drawings, wherein:

FIG. 1 is prior art fiber optic arrangement using prior art patch cords; and

FIG. 2 is a fiber optic arrangement using patch cords according to one embodiment.

### DETAILED DESCRIPTION:

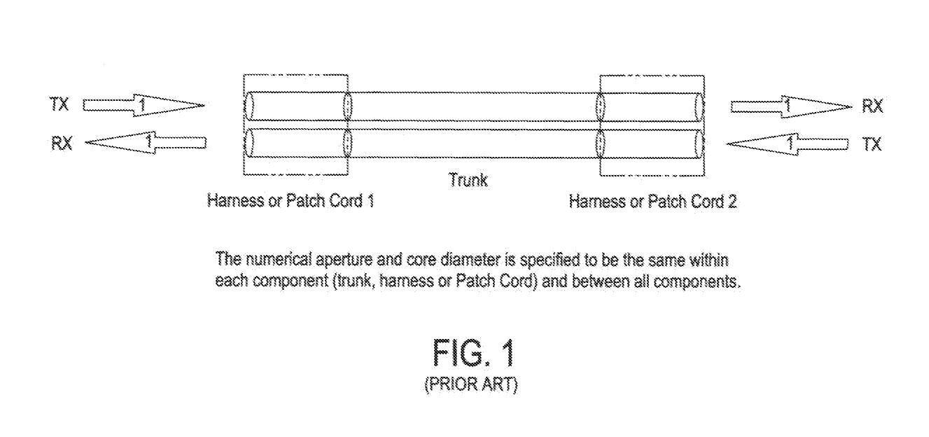

In order to better illustrate the features of the present arrangement, an initial prior art FIG. 1 is shown illustrating a typical fiber optic communications arrangement having a light transmission pathway in each direction. On the left hand side of FIG. 1 is one fiber optic signal transmitter (Tx) and one fiber optic receiver (Rx) with a corresponding receiver (Rx) and transmitter (Tx) on the right hand side. In between the transmitters and receivers is typical fiber trunk arrangement for supporting the transmission of optical signals between the transmitting and receiving components. In between the transmitter and receiver on the left side and the trunk is a first set of optical channels and between the transmitters and receivers on the right side and the trunk is a second set of optical channels. These first and second channels represent fiber optic cable patch cord(s)/harnesses. In some arrangements each channel through the patch cords and trunk may be single fiber cord, or in other arrangements, many channels/fibers can be included in a single patch cord/harness.

Each connection between the transmitters and receivers and the trunk represents one connection point where optical signal power loss can occur. As noted above, the prior art arrangements try to address this power loss by tightening the tolerances of the connectors and fiber geometries which leads to ever increasing manufacturing costs. Thus, in the prior art example illustrated in FIG. 1, the numerical aperture (NA) and core diameter (CD) for each of the fiber segments in the trunk, harness and patch cords are all specified to be the same (e.g. 50 μm for the core diameter (CD) and 0.200 μm for the numerical aperture (NA)).

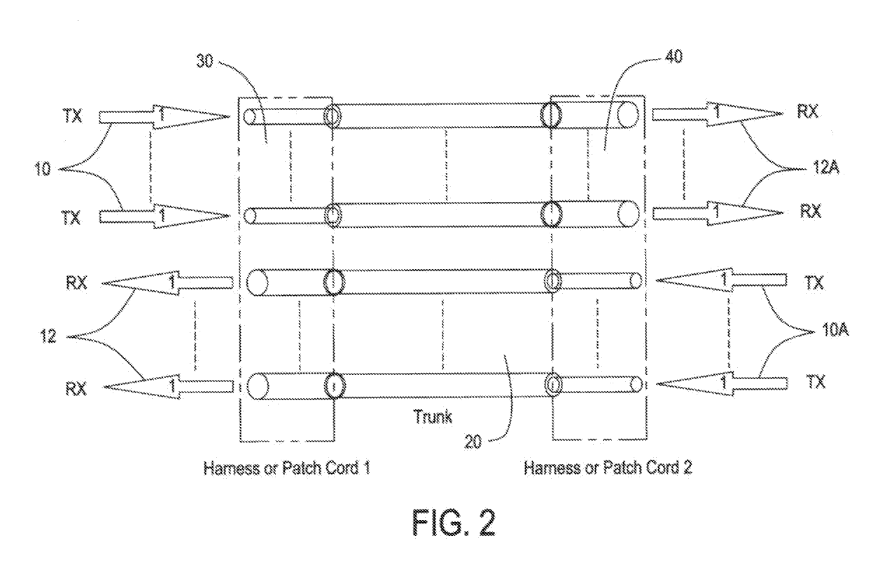

The present arrangement as illustrated in FIG. 2 uses the same basic architecture for the fiber optic arrangement as shown in FIG. 1. In the exemplary present arrangement on the left hand side are a number of fiber optic signal transmitters 10 and a number of fiber optic receivers 12 with corresponding receivers 12A and transmitters 10A on the right hand side and with the same typical trunk 20 arrangement in the middle. As with the prior art, such an architecture requires a first set of optical channels 30 between the transmitters 10 and receivers 12 on the right side and trunk 20, and another second set of optical channels 40 between trunk 20 and transmitters 10A and receivers 12A. These optical channels 30 and 40 between the transmitters 10/10A and receivers 12/12A may be separate fiber optic cables or a single multi-fiber patch cord as desired. As used throughout, any fibers referred to in optical channels 30/40 or trunk 20 are “continuous” across such segments and do not refer to arrangements that include spliced fiber portions within a single span.

Like the prior art, the core diameter and numerical aperture of the fiber cables in trunk 20 could be any value, such as 50 μm and 0.200 μm respectively. In this case and compared to the fiber elements in the trunk cable, the harness or patch cords 30 and 40 use fibers with smaller numerical aperture and/or core diameter on the launch ('transmitter') side of the harness. And, patch cords use fibers elements with larger numerical aperture and/or core diameter on the receive ('receiver') side of the harness or patch cord. In other words as shown in FIG. 2, starting from an exemplary transmitter 10 on the left upper side, the numerical aperture core diameter of the fiber element of the first patch cord 30 for that channel is the smallest in that channel. Then the signal would travel (to the right) through the “normal” sized fiber element in trunk 20, and then finally (again to the right) to receiver 12A on the upper right side through the fiber element of the second patch cord 40 which has the largest numerical aperture/core diameter in the channel. The same arrangement is shown on the second channel from the top in FIG. 2 and the reverse is shown (from right to left) for the bottom two channels in FIG. 2.

As noted above, light is most efficiently coupled into a fiber optic member when the light is with-in the NA & CD. When the NAs & CDs of connected fibers are the same, as in the prior art, misalignment error in the connector results in light signal power loss. This is due to the fact that many connector types such as LC (Lucent Connector), SC (Subscriber Connector) and MPO (Multi-fiber Push on-pull Off) rely on the fiber optic members of different segments to make physical contact or come within a few micrometers of contact in the connector blocks. However, in the present arrangement, when the NA or CD or both NA and CD of the receiving fiber optic member is larger than that of the fiber optic member that the light is exiting, the connector is much less sensitive to alignment errors. In other words, the present arrangement reduces signal power loss because it is easier to hit a larger target than a smaller target.

For example, FIG. 2 represents a typical communication channel comprised of two patch cords and a trunk cable. Following the light path from TX 10 to RX 12A, the CD and NA values could be implemented as follows. The fiber optic member(s) connected to the TX 10 of patch cord 30 have a CD and NA of 50 μm and 0.200 μm respectively. All fiber optic members in the trunk cable 20, regardless of which direction the light is travelling, is 52 μm and 0.215 μm. The fiber optic members in 40, connected to RX 12A, have CD and NA values of 62.5 μm and 0.275 μm. This is the evolution of CD and NA experienced by the light that exits TX 10 and received at RX 12A via the channel in FIG. 2. It is also the same evolution from TX 10A to RX 12 travelling in the opposite direction. Therefore Patch Cord 1 (30) and Patch Cord 2 (40) each purposely contain fiber optic elements whose CD and NA characteristics are different and arranged as such to decrease signal losses experienced at connection points.

It is understood that the above described dimensions are exemplary only and in no way limit the scope of the invention. Any dimensions for CD and NA dimensions for fiber component can be used provided that they increase continuously across the light path from transmitter to receiver. It is likewise understood that the dimensions for fibers used in cords 30 and 40 are otherwise compatible with the requirements of the transmitter/receiver ports of the connected equipment. For example, in practice, patch cords 30 and 40 can be manufactured in many different combinations using different fiber types, such as single mode and multimode, and fibers of the same type, but with different nominal values of CD and NA. The following Table 1 indicates a non-limiting example of possible permutations.

TABLE 1

| | | |
|---|---|---|
| | Fiber(s) | Fiber(s) |
| Example | Connected to TX | Connected to RX |

| Number | CD (um) | NA | CD (um) | NA |
|---|---|---|---|---|
| 1 | 50 | 0.200 | 62.5 | 0.275 |
| 2 | 48 | 0.185 | 62.5 | 0.280 |
| 3 | 49 | 0.200 | 52 | 0.215 |
| 4 | 50 | 0.185 | 62.5 | 0.260 |
| 5 | 48 | 0.190 | 50 | 0.200 |
| 6 | 8 | 0.100 | 62.5 | 0.275 |

The proposed solution would be applicable for channels of various lengths, number of connectors and various fiber types, as well as systems that utilize single fiber (e.g. 1 or 10 Gigabit Ethernet) or parallel optics (e.g. 40 or 100 Gigabit Ethernet) that utilize multiple fibers for transmit and receive.

It is further noted that in some cases a single patch cord 30 may contain multiple fibers, with the patch cord connected to a single transceiver which acts as both a transmitter and receiver. For example in a very basic case, patch cord 30 may have two fibers (with one connector) for connecting to a single transceiver port that has a transmitting side for connecting to one fiber and a receiving side for connecting to the other fiber at the same connection point. Such an arrangement fits well within the above described scheme. In such an arrangement, the fiber in patch cord 30 attached to the transmitter is configured to be the smallest fiber (CD and NA) in the light path to the eventual receiver port and the fiber in patch cord 30 attached to the receiver is configured to be the largest fiber (CD and NA) in the light path to the eventual transmitter port. Thus, within one patch cord 30, representing one segment of two different light paths (Rx→Tx and Tx→Rx) there may be two different fibers of different diameters (CD and NA). The orientation to assure that the correct fiber of the correct diameter links up to the transmitter side or receiver side of the transceiver port can be addressed through proper labeling and keying of the connector of patch cord 30.

While only certain features of the invention have been illustrated and described herein, many modifications, substitutions, changes or equivalents will now occur to those skilled in the art. It is therefore, to be understood that this application is intended to cover all such modifications and changes that fall within the true spirit of the invention.

1. A fiber optic arrangement comprising:
first and second light transceiving devices; and
at least two light paths between said first and second transceiving devices, connecting through a trunk, one said light path going in a first direction from said first transceiver to said second transceiver and a second of said light paths going in the opposite direction from said second transceiver to said first transceiver,
said light paths each having at least first and second segments on either side of said trunk between said transceivers,
wherein said trunk has connecting fiber elements for both of said light paths, said trunk connecting fiber elements having a first dimension,
wherein for said first light path, said first segment is located proximate to a light transmitting device of said first transceiver and has a dimension lesser than said dimension of said trunk connecting fiber elements and
wherein said second segment is located proximate to a light receiving device of said second transceiver and has a dimension greater than said dimension of said trunk connecting fiber elements;
wherein for said second light path going in the opposite direction, said first segment is located proximate to a light transmit tin device of said second transceivers and has a dimension lesser than said dimension of said trunk connecting fiber elements and
wherein said second segment is located proximate to a light receiving device of said first transceiver and has a dimension greater than said dimension of said trunk connecting fiber elements.

2. The fiber optic arrangement as claimed in claim 1 wherein each of said first and second segments of said light paths on either side of said trunk has a numerical aperture (NA) and a core diameter (CD).

3. (canceled)

4. The fiber optic arrangement as claimed in claim 3 wherein said numerical apertures (NA) and a core diameters (CD) of said first and second fiber optic element of said first segments of said light paths are less than the numerical aperture (NA) and a core diameter (CD) of both said trunk and said second fiber optic element of said second segments of said light paths.

5. The fiber optic arrangement as claimed in claim 1, wherein said dimension of said first fiber optic elements relative to said first dimension of said trunk and said dimension of said second fiber optic elements is such that signal power losses in said light paths is less than 0.75 dB per connection.

6-8. (canceled)
